(19) United States
(12) Patent Application Publication
(10) Pub. No.: US 2005/0109167 A1
(43) Pub. Date: May 26, 2005

(54) Nut installation tool

(76) Inventor: Ivan Ainsworth, Campbellford (CA)

Correspondence Address: HODGSON RUSS LLP, ONE M & T PLAZA, SUITE 2000, BUFFALO, NY, 14203-2391, US

(21) Appl. No.: 10/968,421

(22) Filed: Oct. 18, 2004

(30) Foreign Application Priority Data
Oct. 16, 2003 (CA) 2445225

(51) Int. Cl. B25B 13/50

(52) U.S. Cl. 81/121.1

(57) ABSTRACT

A nut installing tool comprises a body extending from a first end to a second end, said first end defining a conical opening tapering inwardly to an inner wall, said inner wall defining a centrally oriented socket, adapted to accept a nut. The body includes a non circular drive recess at the second end thereof, providing means for insertion of a drive means for rotating the body about a central axis extending between said ends, and thereby rotating said nut. The centrally oriented opening is hexagonal in shape, being adapted to receive a hexagonal shaped nut. The drive recess is square shaped. Alternately or additionally, the outer surface of the second end is shaped with a plurality of flat sides which provide gripping means for wrench means to rotate the tool.

### FIELD OF THE INVENTION

The present invention relates to a tool for holding and rotating a nut for securement thereof upon a threaded stud or the like.

### BACKGROUND OF THE INVENTION

Various tools are known which include a socket at one end for accepting a nut, such as a standard hexagonal shaped nut, defining a threaded bore therethourgh, and a recess at the other end, shaped and oriented to accept a standard socket wrench handle drive for rotating the tool to cause the nut to turn for theaded engagement upon a stud or the like.

It is often desired to secure a washer and compression spring between the head of a stud and the nut, such as in an automotive exhaust manifold spring kit. Using a tool typical of the prior art to secure a spring, washer and nut to a stud, such as a stud of an automotive exhaust manifold pipe is cumbersome in that the user must manually hold the spring and washer on the stud until the nut has been suitably threadably engaged upon the stud. Given that studs are often positioned in difficult to reach areas, it is a distinct disadvantage to have to hold the spring and washer in place during initial engagement of the nut upon the stud.

### SUMMARY OF THE INVENTION

It is an object of the present invention to overcome, inter alia, the shortcomings of the prior art described above by providing a tool adapted to for securing a nut upon a stud, the tool adapted to hold a spring and washer between the stud and nut.

In accordance with an aspect of the invention there is provided a nut installing tool comprising a body extending from a first end to a second end. The first end defines a first opening extending inwardly to an inner wall. The inner wall defines a centrally oriented socket adapted to accept a nut. The body includes drive accommodating means at the second end thereof, providing means for engagement of a drive means for rotating the body about a central axis extending between said ends, and thereby rotating said stud. The drive accommodating means may comprise a non circular drive recess at the second end the body, providing means for insertion of a drive tool for rotating the body about the central axis, and thereby rotating the nut. Alternately or additionally the drive accommodating means comprises the outer surface of the second end being shaped with a plurality of flat sides which provide gripping means for a wrench or the like to rotate the tool.

Other advantages, features and characteristics of the present invention, as well as methods of operation and functions of the related elements of the structure, and the combination of parts and economies of manufacture, will become more apparent upon consideration of the following detailed description and the appended claims with reference to the accompanying drawings, the latter of which is briefly described hereinbelow.

### BRIEF DESCRIPTION OF THE DRAWINGS

FIG. 1 is a front left perspective view of an embodiment of a tool in accordance with the invention;

FIG. 2 is a rear and right perspective view of an embodiment of the tool of FIG. 1 in accordance with the invention;

FIGS. 3A and 3B are section views of the embodiment of the invention shown in FIGS. 1 and 2; and

FIG. 4 is a section view of a further embodiment of the tool of the invention including a spring loaded swivel attachment for the tool of the invention.

### DETAILED DESCRIPTION OF EMBODIMENTS OF THE INVENTION

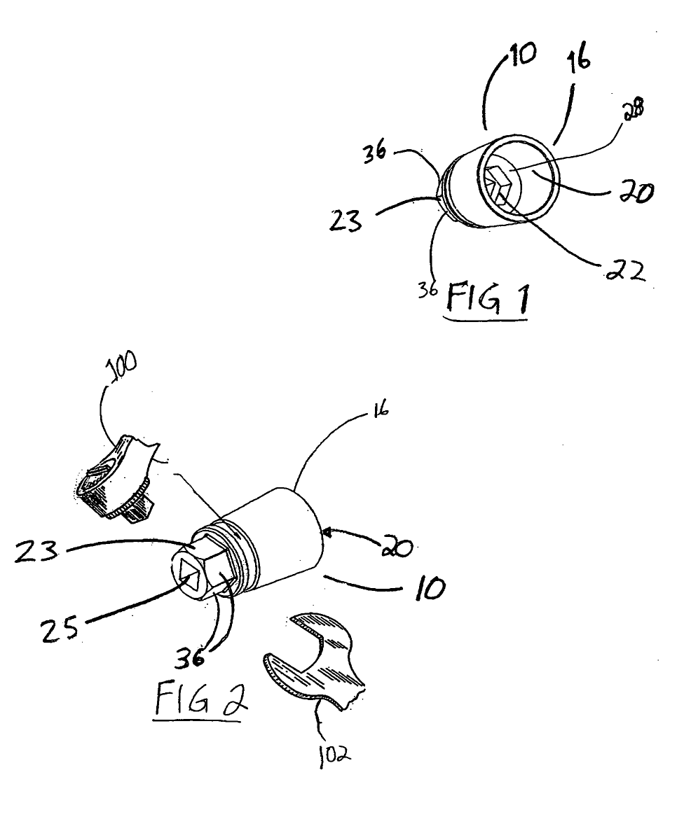

With general reference to FIGS. 1, 2, 3A and 3B, an embodiment of the present invention of the nut driving tool is illustrated, and is designated by the general reference numeral (10).

This tool is designed to hold a nut, and optionally a washer and spring in such orientation to allow for securing same onto a stud. The tool is particularly useful for securing the nut, washer and spring on as a stud positioned in a difficult to reach area. An example of a preferred application of the tool is the attachment of a standard spring kit (comprising a nut, washer and spring) to automotive exhaust manifolds studs.

As shown in FIGS. 1 to 3, the tool has a body extending from a first end (16) to a second end (23), said first end defining an opening (20) which is preferably conical tapering inwardly to an inner wall (24). The inner wall defines a further centrally oriented socket (22) which is preferably hexagonal shaped, being sized to fit a nut of a standard particular size, for example ⅜^{th} or 9/16^{th} inch.

On the opposite side of the tool to the conical opening (20), is a second end (23) of the tool (10), which includes drive accommodating means such as a non circular drive recess (25). The non circular drive recess provides means for insertion of a drive means for rotating the body about a central axis extending between said ends, and thereby rotating said stud when positioned in socket (22). The drive recess (25) is shaped to accept an extension tool such as a standard socket wrench (100) to turn or rotate the body to advance or remove the nut from the stud (not shown). The driving recess may be shaped to accommodate a square drive (as shown in FIGS. 1 to 3) or any other suitable shape for accepting an implement for rotating the tool about its axis. The preferred sizes of the square drive recess square is ¼, ⅜, ½ or ¾ inch or any other size to be utilized with a standard driving instrument. Alternately or additionally the drive accommodating means may be provided by having the outer side surface of the second end (23) of the tool being shaped with a plurality of flat sides (36) which provide gripping means for a wrench, such as wrench (102), to turn or rotate the tool. The tool may also be rotated by a tool, such as a wrench or the like, secured to the outside surface of the lower portion (23) of the tool.

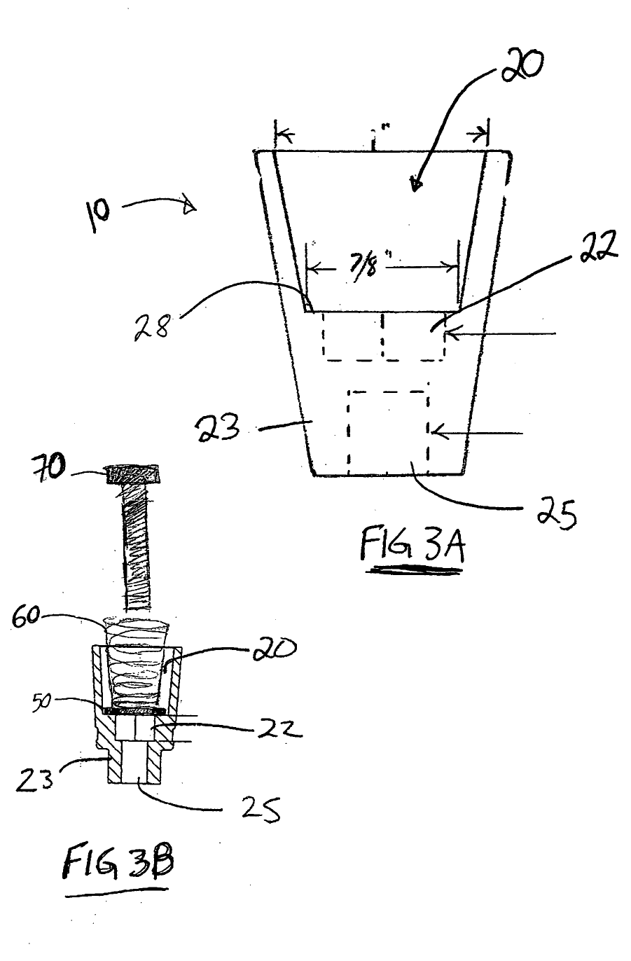

The tool may be utilized to secure a nut to a stud as follows: A standard hexagonal shaped nut with threaded bore therethrough is inserted into socket (22). As shown in FIG. 3B, a washer (50) is placed on the top of the nut, resting against the inner wall (28). The opening (20), which is preferably conical, tapers outwardly as it extends away from the inner wall (28). The conical opening (20) is sized and shaped such that it allows a compression spring (60) (such as a conical spring shown schematically by way of example in FIG. 3B) to be inserted in an upright position into opening (20), resting on the washer (50). Preferably, the conical opening tapers from approximately 1 inch at the outside of the opening approximately 7/8 inch at the position of the inner wall, with centrally oriented socket (22) being smaller in diameter than the diameter of the conical opening (20) at the position of the inner wall, such that the inner wall (50) creates a ledge upon which the washer and spring may sit. With the nut positioned in the centrally oriented socket (22), the washer (50) is placed at the bottom of the conical opening resting on the inner wall. As shown in FIG. 3B, the spring (60) is positioned upright in the conical opening (20). The conical opening is then inserted over stud (70) (such as an exhaust manifold stud), such that the stud extends through the spring and washer and into contact with the nut, at which point the tool may be rotated causing engagement of the stud onto the nut.

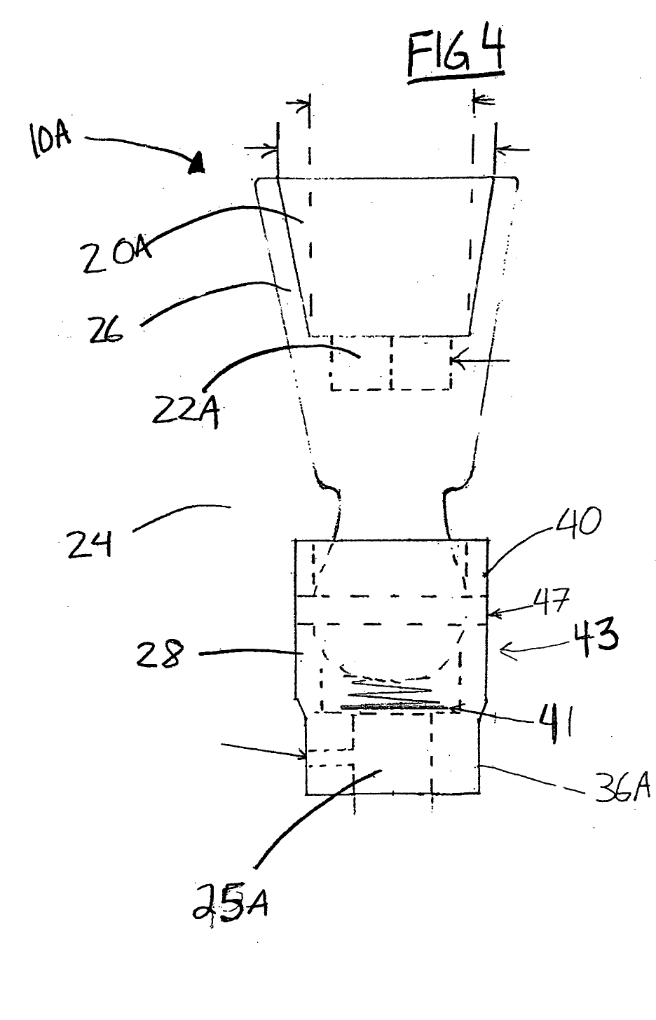

As shown in FIG. 4, to assist in the convenience of driving the tool, a second embodiment of the tool (10A) includes an first member (26) having a preferably conical opening (20A) and centrally oriented socket (22A) into which the nut, spring (60) and washer (50) may be inserted as described above. A second member (40) is attached to the first member (26) by a spring loaded (41) swivel ball joint (43). The lower member includes drive accommodating means, such as drive recess (25A) sized to be utilized with a standard driving instrument. Alternately or additionally the drive accommodating means may be provided by having the outer side surface of the second member (40) of the tool being shaped with a plurality of flat sides (36A) which provide gripping means for a wrench, to turn or rotate the tool. The first member is swivelable and securably into various swivel positions by means of a pin or the like insertable into passage (47) relative to the second member thereby allowing driving of the tool from various angles, which is especially useful in tight fitting areas of an automobile.

It is to be understood that while but two embodiments of the present invention have been herein shown and described, it will be understood that various changes in size and shape of parts may be made. It will be evident that these modifications, and others which may be obvious to persons of ordinary skill in the art, may be made without departing from the spirit or scope of the invention, which is accordingly limited only by the claims appended hereto, purposively construed.

1. A nut installing tool comprising:
a body extending from a first end to a second end, said first end defining a first opening extending inwardly to an inner wall, said inner wall defining a centrally oriented socket, said centrally oriented socket adapted to accept a nut, said body including a non circular drive recess at the second end thereof, providing means for insertion of a drive means for rotating the body about a central axis extending between said ends, and thereby rotating said nut.

2. A nut installing tool as recited in claim 1 wherein said first opening is conical, tapering inwardly toward said inner wall, and said centrally oriented opening is hexagonal in shape, being adapted to receive a hexagonal shaped nut.

3. A nut installing tool as recited in claim 1 wherein said centrally oriented socket is adapted to accept a 3/8 inch hexagonal nut.

4. A nut installing tool as recited in claim 1 wherein said drive recess is square shaped.

5. A nut installing tool as recited in claim 4 wherein said drive recess has inner sides each of ¼, ⅜, ½ or 3/4 inch.

6. A nut installing tool as recited in claim 1 wherein the outer surface of the second end is shaped with a plurality of flat sides which provide gripping means for wrench means to rotate the tool.

7. A nut installing tool comprising:
a body extending from a first end to a second end, said first end defining a conical opening tapering inwardly to an inner wall, said inner wall defining a centrally oriented socket, said centrally oriented socket adapted to accept a nut, said body including drive accommodating means at the second end thereof, providing means for engagement of a drive means for rotating the body about a central axis extending between said ends, and thereby rotating said nut.

8. A nut installing tool as recited in claim 7, wherein said drive accommodating means is a non circular drive recess at the second end thereof, providing means for insertion of a drive means for rotating the body about a central axis extending between said ends, and thereby rotating said nut.

9. A nut installing tool as recited in claim 7 wherein said drive accommodating means comprises the outer surface of the second end being shaped with a plurality of flat sides which provide gripping means for wrench means to rotate the tool.

10. A nut installing tool comprising: a first member having a first end defining a first opening extending inwardly to an inner wall, said inner wall defining a centrally oriented socket, said centrally oriented socket adapted to accept a nut, and a second member including drive accomodating means providing means for engagement of a drive means for rotating the tool, said second member connected to said first member by means of a releasably lockable swivel joint.

11. A tool as recited in claim 10 wherein said drive accommodating means is a non circular drive recess defined in said second member, providing means for insertion of a drive means for rotating the tool and thereby rotating said stud.

12. A nut installing tool as recited in claim 11 wherein said drive accommodating means comprises the outer surface of the second member being shaped with a plurality of flat sides which provide gripping means for wrench means to rotate the tool.

13. A nut installing tool as recited in claim 10 wherein said first opening is conical, tapering toward said inner wall.

14. A method of using the tool of claim 1 comprising the following steps:
inserting a nut, having a threaded bore therethrough in said centrally oriented opening;
positioning a washer against the inner wall, said washer having a central opening aligned with the opening of said nut;
positioning a compression spring within said conical opening;
inserting a threaded stud, through said spring and washer into engagement with said nut;
engaging driving means with the second end; and
rotating said tool about said central axis, thereby rotating said nut onto said threaded stud.
